(19) United States
(12) Patent Application Publication
(10) Pub. No.: US 2002/0152285 A1
(43) Pub. Date: Oct. 17, 2002

(54) Remote office system for retail and other sales and services

(76) Inventors: Troy M. Wheeler, Meridian, ID (US); Andrew P. Adolphsen, Meridian, ID (US)

Correspondence Address: PEDERSEN & COMPANY, PLLC, P.O. BOX 2666, BOISE, ID, 83701, US

(21) Appl. No.: 10/061,954

(22) Filed: Jan. 31, 2002

Related U.S. Application Data
(60) Provisional application No. 60/265,715, filed on Jan. 31, 2001.

(51) Int. Cl. G06F 15/16

(52) U.S. Cl. 709/218; 709/250

(57) ABSTRACT

The described remote office system is designed for providing improved data acquisition and transfer from a remote sales location to a home office, and access to and use of home office information systems by the remote personnel. The office system comprises an “on-site” system, which is typically a central router placed at the home office and operatively connected to the home office computer system and to a communications network, such as a telephone network. The “offsite” system is at a location distant from headquarters/home office, such as a remote sales event, and is also connected to the communications network. The offsite system includes a plurality of electronic components packaged conveniently and durably and pre-configured with proper call-up and address information. This way, the remote system contacts the home office system and the remote system is identifiable by the home office system. The offsite system is an portable hub with integral components, which permits operation of numerous remote terminals and printers with a single dial-up connection to the central router at the home office.

This application claims priority of prior provisional application Serial No. 60/265715, filed Jan. 31, 2001, entitled “Remote Office System for Retail Services,” which is hereby incorporated herein by this reference.

### BACKGROUND OF THE INVENTION

1. Field of the Invention

This invention relates generally to computers and computer records convenient or necessary for retail, wholesale, or other sales transactions. More specifically, this invention relates to a computerized office system for creating and obtaining records for sales that are “offsite” in that they are at a distance from the main business, such as at a temporary sales location.

2. Related Art

Presently, specialized computer software programs exist for retail transactions, for example, for vehicle retail. Typically these programs are installed on a PC or server at the auto/truck dealership, and help the salespersons and managers understand inventory, the cost in each vehicle, purchaser's credit qualifications, finance and insurance, accounting, etc.

Also, there is a popular trend in marketing, for example, of autos/trucks, which involves remote, away-from-the-dealership sales events. Often, these remote events are designed to create a festival or close-out atmosphere. The presence at the remote events of several competing dealerships also permits convenience on the part of the prospective purchaser for comparison shopping.

At the remote sales events, however, it is usually necessary to set up a remote computerized office system to assist with the sales transactions. This requirement is often satisfied by setting up a remote copy of the office system from the dealership, complete with multiple PC's, servers, monitors, modems, dedicated terminals and extensive cabling to interconnect all of these components, even though the system typically is only used for a few days. This results in a difficult and expensive set-up job. So, there exists a need in the auto/truck marketing industry specifically, and in the retail industry generally, for a convenient and inexpensive remote, computerized office system for retail, wholesale, and other sales and services. This invention addresses that need.

### SUMMARY OF THE INVENTION

The present invention is a remote office system for retail, wholesale, or other sales or services or for other remote or temporary job or business sites, wherein the remote office system provides easy and substantially automatic connection and communication with a headquarters/home office computer system. The preferred embodiment may include automatic start-up (such as “plug and play” performance, and/or self-diagnostic performance. The invented remote office system preferably comprises a onsite central router and an offsite system. The central router is typically located at the business headquarters or home office, and is operably connected to the headquarters or home office computer system and operably connected to a public telephone network or other communications network. At the remote sales site, the offsite system is also operatively connected to, for example, the public telephone network. The offsite system serves as an integral, portable hub which permits operation of numerous remote terminals, PC's, printers or other network devices, with a single dial-up connection to the central router at headquarters. “Network devices” may include, for example, various data entry, date acquisition, data storage, and/or data output equipment.

The offsite system of the present invention comprises a high-impact material, such as high-impact molded plastic, case that protects and encloses the invented combination of equipment in a manner that is conducive to easy transport, quick set-up, repeated use even in rough environments, and quick take-down. Mounted securely within the case are a modem router, a terminal server, an RJ-45 patch panel, a case face panel and various connection cabling. The high-impact 21 case provides easy and rugged portability of the system, and the combination of equipment inside the case provides an “all in one” package that is easily operated by personnel without substantial computer or programming experience.

The modem router provides direct-dial remote access to the headquarters computer system via, for example, the public telephone network. The modem router also provides distribution of computer connectivity to multiple remote devices, such as multiple terminals in the vehicle retail application, or to multiple PC's or other network devices in many other alternative applications.

The terminal server translates network communications to and from the modem router into serial communications to and from the remote devices. The RJ-45 patch panel provides a physical interface for connecting multiple remote devices. The face panel protects the offsite system from environmental hazards, and provides mounting support for the RJ-45 patch panel.

The combination of preferably all these components securely installed inside the high-impact material case results in a new apparatus for servicing remote retail or wholesale transactions, or other job-site, military, or humanitarian aid operations. In addition, these specific components are preferably organized and connected with customized settings/configurations which result in a field-ready remote office system for each customer's particular uses and local phone number.

The invention also may comprise methods of remote retail or wholesale or other sales, wherein the components necessary to interface between remote terminals/printers and a headquarters/home office computer system are provided in a single box for plugging in at the remote location and in a single “box” (which may comprise only a central router) for plugging in at the headquarters/home office. “Plugging in” at the remote location comprises 1) in the case of a telephone carrier, plugging the phone line into the single box, and 2) connecting the remote terminals and/or printers into the patch panel of the single box, and 3) plugging the power cord of the single box into a power source. The offsite single box then automatically “starts up” by dialing the home computer via the central router. “Plugging in” at headquarters/home office comprises connecting the central router to the onsite computer system and connecting the central router to the telephone network. Thus, a company may install the central router onsite, and hand the pre-configured offsite single box to a user for transport to the remote location. The user then plugs in the office single box as above and is ready to do business at the remote site. “Doing business” may include, for example, accessing databases, forms, guidelines, credit reports, invoicing and price/cost information, and may include submitting filled-out forms or other information to the staff at the home office.

The preferred combination of components securely installed inside the high-impact material case, according to the invention, results in an apparatus for trouble-free servicing remote retail or wholesale transactions. In addition, the components are organized and connected with customized settings and configurations which result in a field-ready remote office system for each customer's particular uses, and for each customer's particular local phone number or other preferred communication carrier.

### BRIEF DESCRIPTION OF THE DRAWINGS

FIG. 1 is a schematic depiction of one embodiment of the remote office system of the invention, with the offsite system surrounded in dashed lines and the onsite unit at the dealership office surrounded in dotted lines.

FIG. 2 is a perspective view of one embodiment of the offsite unit, with lid open.

FIG. 3 is a schematic view of the offsite unit connected to multiple terminals, and communicating via phone network to the onsite router and onsite computer system.

FIG. 4 is a perspective view of one embodiment of a central router for the onsite system.

### DETAILED DESCRIPTION OF THE INVENTION

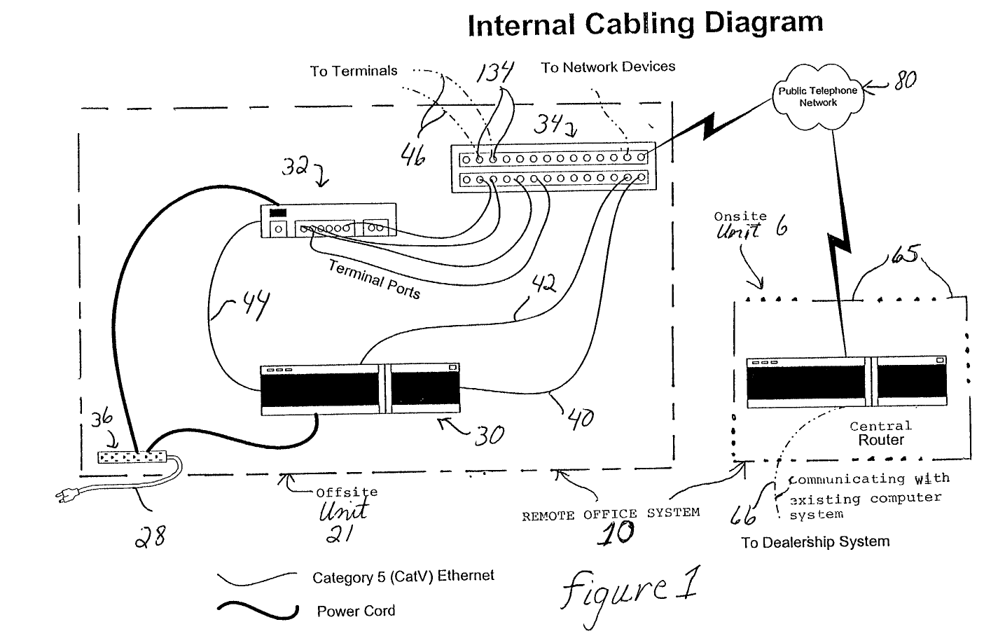

Referring to FIG. 1, there is shown one embodiment of the invented remote office system, which comprises an “offsite system” and a “central router”. The “offsite system” is installed at the “offsite” or “remote” location, connected to a plurality of terminals such as the “dumb” terminals typically used on sales desks. The “central router” is installed at the headquarters, connected to the headquarters computer system. The modem router of the offsite system establishes a network connection to a remote computer system over an analog phone line, via the central router that is added to the already-existing headquarters computer system. The modem router then allows multiple devices (terminals, PC's, or other network devices at the remote location) to connect to the headquarter computer system through the network connection. In the preferred embodiment for cooperation with vehicle sales terminals, the terminal server can translate serial computer signals to and from network communications. The patch panel is an external interface for connecting devices. The high-impact material case and face panel together provide a secure and portable housing. The modem router part could be replaced with three separate parts that would perform each of its three functions individually, namely, network routing, Ethernet hub, and a modem or other media access layer device. The case and face panel could both be changed including material and size as long as together the resulting case provided secure and durable portability of the system.

The preferred remote office system of the invention is pre-configured. In the preferred embodiment, which is adapted for use in vehicle retail, the invented system is pre-configured to be compatible with either Reynolds and Reynolds or ADP programming, which are the preferred commercially-available computer systems typically provided to vehicle retail headquarters. This way, the invented system is compatible with the computer systems already installed at vehicle dealerships, and the user needs to do very little to start-up and use the invented system. The user connects a phone line to the provided jack marked “phone line in” on the offsite system, plugs the offsite system's power cord into a power supply, and waits for the offsite system to automatically start-up. Throughout the start-up, the user need not press buttons or program or type any information into the offsite system—instead, the offsite system's customized settings and configurations automatically execute connection to the public telephone network and allow remote operation with only minimum input from the user, that is, preferably the “plugging in” of two cords/cables. The preferred pre-configuration, done prior to or at the time the remote office system is sold to the vehicle retailer, comprises only the dial-out telephone number and the network address being input into the offsite system. Examples of pre-configuration of the telephone number and network address according to the invention are given below.

As may be seen in FIG. 1, the preferred offsite system may communicate with a plurality of dumb terminals and/or a plurality of network devices such as PC's. Alternatively, in applications where the user wishes to exclusively use PC's rather than dumb terminals, the offsite system could optionally be adapted by removing the terminal server, and, optionally, by adding a network hub to the offsite system. Pre-configuration for such a PC-adapted office system preferably also only includes a telephone dial-out number (or other communication dial-up) and the network address.

The preferred pre-configuration may be done under the general categories/steps of setting the offsite system dial-out number and setting the Etherlite (terminal server) IP address, for a specific communications carrier and specific network. Thus, once pre-configured, the invented system will automatically dial-up the appropriate carrier connection to the connect to the home-office/headquarters computer network, typically via the central router provided as part of the invented system. The properly pre-configured dial-out allows for immediate network communication between the offsite system (actually, the offsite system connected to the remote terminals) and the headquarters system over the wide area connection. The properly pre-configured network address allows the headquarters computer network to recognize and communicate with the offsite system(s). The invented remote office system is designed so that pre-configuration may be done by qualified personnel before the system is delivered to the purchaser, and so that re-configuration may not be easily or accidently done during installation offsite or during use.

Preferred applications and pre-configurations are for remote point of sale use, for example, in auto sales, consumer retail, or promotional events. In the auto sales application, for example, a large amount of information, accounting, and contract or sales or service agreement forms, may be made available to the offsite location from the home office. The invented system may be adapted for businesses or agencies to carry on teleconferencing between various locations. Other applications are possible, such as various “job site” applications, for example, construction sites, logging sites, petroleum exploration and drilling, or mining sites. Other applications might also include field operations, for example, military, United Nations, or Peace Corps operations, or emergency or humanitarian aid command post operations. Many different entities, that is, agencies, organizations, or businesses, may find the invented remote office system beneficial, especially with pre-configurations that are customized to their particular use, and to the appropriate telephone, wire or wireless communication system. These different entities all might need databases, maps, forms, accounting services, supply information, employee relations information, or other files or assistance from the “home office”. These entities will be able to quickly install the invented system for use, without requiring computer personnel to be on the site to install, program, and operate the invented system.

The invented system may be adapted and pre-configured for various carriers besides telephone. For example, DSL, cable, satellite, broadband wireless, T-1 or T-3 may be used. Asynchronous Transfer Mode (ATM), fiber distributed data interface (FDDI), or frame relay may be used.

Referring to FIG. 1, there is shown a schematic diagram of the major components of the invented system. The invented Remote Office System 10 is generally comprised of two systems, that is, the offsite system 20 and the onsite system 60.

The offsite system 20 comprises an offsite unit 21 including case 22 that is durable and preferably water tight and resistant, preferably by use of a seal member 47′ between the lid 47 and the main body of the case. Inside the case 22 one sees a top internal panel 24 which includes ports 134 for cables from terminals 50 or other network devices 52, phone line connection means 82 for the phone line, a power cord 28 tied down for transport, and indicia 26 as desired. A power plug 28 extends from the case 22 for connection to an electrical power outlet. Inside the case, underneath the top internal panel 24 and hidden from view by the user, are the components and cabling/wiring between the components that operatively connects the components. Preferably, the components are anchored to the inside bottom wall of the case 22 and/or to the panel 24, in a predetermined arrangement that permits efficient use of space and volume inside the compact case, while also providing for safe and non-vibrating transport and use of the case and its components. Preferably, the case is on the order of about 2 feet wide×1.5 feet deep×1 foot high in dimension, but may be other dimensions as required by particular components.

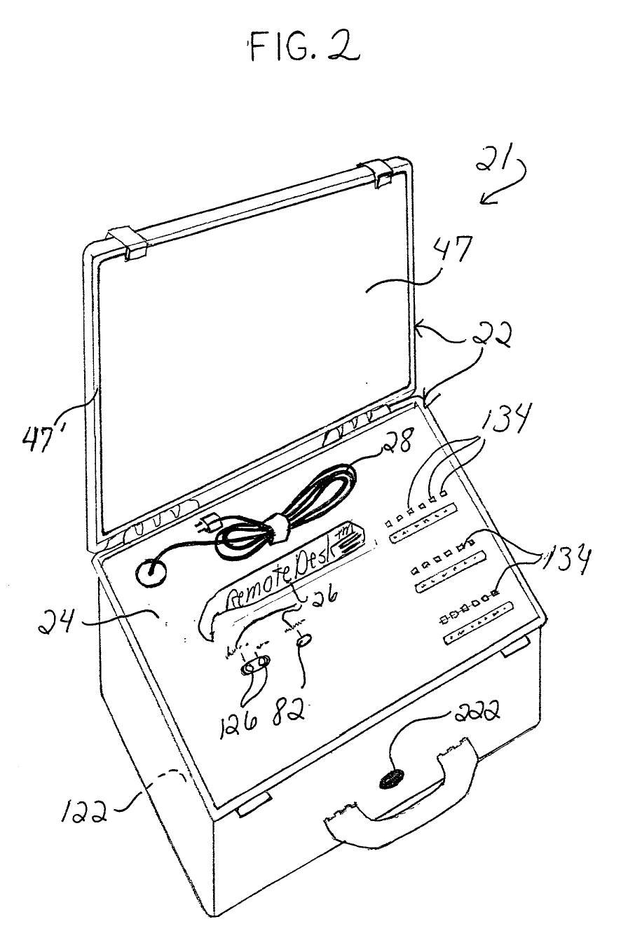

The components preferably comprise a modem router 30, a terminal server 32 such as a Etherlite™ terminal server, a patch panel 34, and a power strip 36, connecting to the power cord 28 that exits the case. As illustrated in FIG. 1, the modem router 30 and terminal server 32 are both powered by the power source. Connections between the modem router 30 and the patch panel comprise a phone-line-in 40 and a network port line 42. The modem router 30 is also operative connected to the terminal server 32 by line/cable 44. Terminal port lines 46 extend from the terminal server 32 to the patch panel, from which lines/cables extend to the plurality of terminals 50 or network devices 52 at the “offsite” location. These terminals or network devices, for example, may be dumb terminals or other equipment at the remote sales site, as discussed above. FIG. 2 illustrates the preferred embodiment of the offsite unit 21, with the case lid 47 open to reveal the top internal panel 24, with its terminal plug-in ports 134 for cables from terminals 50 or other network devices 52, phone line connection means 82 for the phone line, a power cord 28 tied down to the panel 24 for transport, and indicia 26 as desired, including LED's 126 or other lights and signals to indicate status and operation of the offsite unit 21.

The onsite system 60 comprises an onsite unit 61 communicating to an existing information system 68 at the main office or headquarters. The onsite unit 61 is a central router 64 inside its own housing or inside a case 65. The central router 64 includes adaptation such as cabling 66 to an existing computer system or other information system 68 at the onsite location. The existing information system 68 includes programming/software/databases such as Reynolds and Reynolds or ADP programming, which are the current standards for the vehicle retail computer software.

The offsite system 20 and onsite system 60 communicate, for example, by a public telephone network 80, so that the offsite unit 21 may dial up the central router, the central router/existing computer system may recognize the offsite unit, and two-way communication may commence between the offsite unit 21 and onsite unit 61.

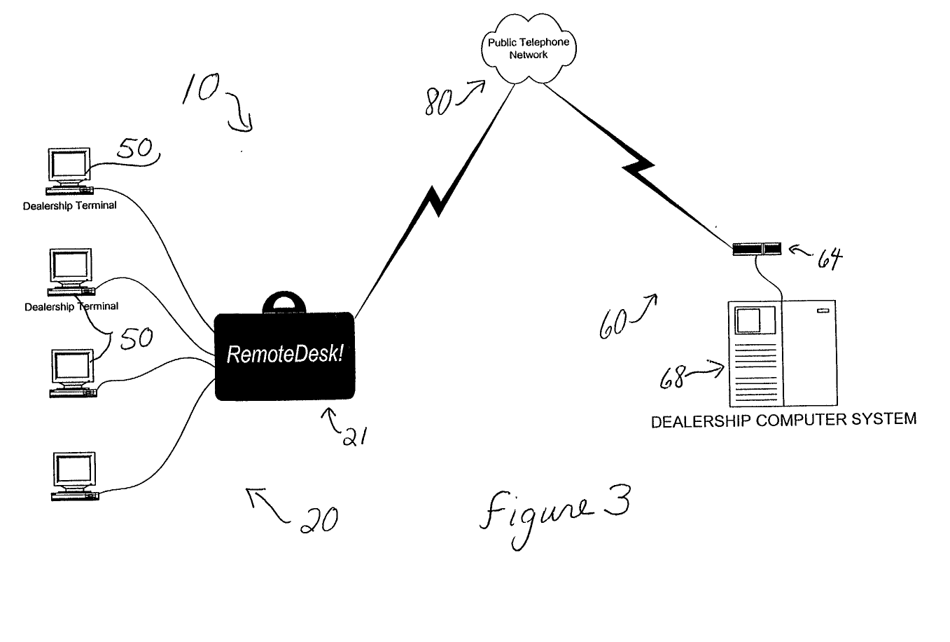

FIG. 3 illustrates the preferred embodiment of the offsite unit 21 connected by phone network 80 to the central router 64, which is in turn connected to the existing onsite information system. Up to 16 dealership terminals 50 may be operatively connected to the offsite unit 21, so that up to 16 individuals may communicate with and work with headquarters and the headquarters computer system at one time.

As described above, the offsite unit 21 is pre-configured and pre-programmed to have the proper terminal server IP address, and to automatically start-up when plugged into an electrical outlet automatically dial-up the proper phone number representing the proper central router and existing computer system. This way, virtually hand-free and automatic connection to the onsite computer system is achieved by the offsite personnel, and that personnel need not understand nor perform any computer programming or complex operations.

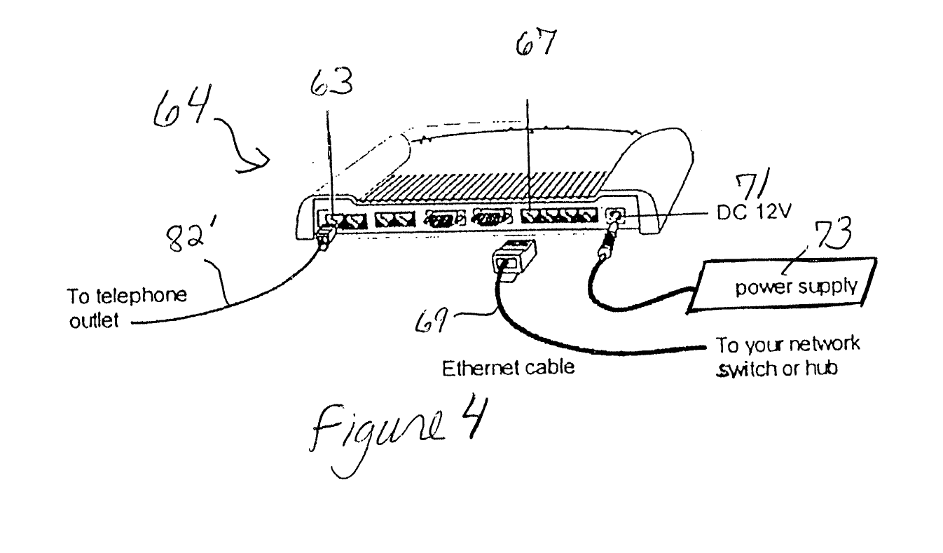

As shown in FIG. 4, the central router 64 comprises a connection 63 for “modem 1 line” (phone cord 82′ to telephone jack at onsite location), a Ethernet 1/H connection 67 for Ethernet cable 69 (to onsite network switch or hub), and a connection 71 for a power cord to a DC 12V power supply 73.

By way of example, the following steps illustrate operation of the Remote Office System 10:

### EXAMPLE OF OPERATION AND USE

Getting Ready to Use The Remote Office System 10

1. Configure ports on the particular dealership information system with which the Remote Office System 10 will be used.

2. Set up the Offsite Unit 21 on a desk or table at the remote retail location, such as the “tent sale.”

3. Connect the terminals or PC's to the Offsite Unit 21.

4. Supply power to the Offsite Unit 21, wherein the power outlet is within 4 feet of your Offsite Unit. Use an 110V AC, 50-60 Hz power source that is grounded, protected from surges, and supported by a battery.

5. Supply the Offsite Unit 21 with a dedicated analog phone line. Use a line that is free of noise and static. The phone cord should be connected through an inline surge protector to prevent power surges from damaging the Offsite Unit 21. Avoid using lines shared by other devices such as fax machines or modems. Also, avoid using lines with features such as call waiting or voice messaging. Do not use lines connected to phone switching equipment. Connecting the Offsite Unit to a digital phone switch could damage the phone switch and/or the modem in the Offsite Unit.

Connecting the Offsite System 20

1. Connect the phone cord provided to the jack marked “Phone Line In.”

2. Plug the power cord for the Offsite Unit into the offsite power supply. The Terminal Link LED then illuminates solid green.

3. The Offsite Unit automatically begins dialing the Onsite System 60, that is, the provided central router 64. Offsite Unit 21 cooperation with the phone network may 4 or 5 minutes to complete the connection. Once the two systems are connected, the Modem Status LED on the Offsite Unit 21 illuminates green and/or orange.

Connecting Terminals and Serially Connected PCs

1. If adapters were included with your Offsite System, replace any existing adapters on your terminals or PCs with those provided.

2. Connect one end of the straight-through Ethernet (10BaseT) CAT5 cable provided with the Remote Office System 10 to a terminal port on the Offsite Unit 21 and the other end to your terminal or PC. Repeat for all terminals or PCs being used at the remote offsite location.

Connecting Ethernet Devices

The Network Port on the Offsite Unit 21 is an autosensing crossover 10BaseT port. This port may be used to connect one or more Ethernet devices.

Offsite System 20 Status LEDs

The color of the LEDs indicates the status of the Offsite System.

| | |
|---|---|
| Terminal Link | |
| Green | The Offsite Unit has power and is on. |
| Orange | Network activity is occurring on the terminal ports. |
| Network | |
| Green | An Ethernet device is connected to the network port. |
| Orange | Network activity is occurring on the network port. |
| Modem Status | |
| Green | The Offsite Unit modem is connected. |
| Orange | The Offsite Unit is transmitting or receiving information |
| | through the modem. |

If the Case for the Offsite System Does Not Open

1. If you cannot open the case 22 of the Offsite Unit 21 after a change in altitude, loosen the Offsite Unit's pressure-relief valve (accessible on the outside of the case 22 to the user) one or two turns. You may hear a short hiss of air as the pressure inside the case equalizes with the local atmospheric pressure. After about 20 seconds, close the pressure-relief valve 222 and open the case.

2. In the preferred embodiment, it is important to keep the pressure relief valve near the handle closed during use and travel, except as noted in (1) above, as the Offsite System case is designed, generally, to release inside pressure automatically.

Connecting the Central Router at the Onsite Location

To connect the central router 64 to the phone line and your network switch or hub, follow the steps and illustration below.

1. Connect one end of the Ethernet cable to Port 1/H on the central router 64 and the other end to the 10BaseT port on the network switch or hub.

2. Connect the phone cord to the Modem 1 Line jack on the central router and to the dedicated analog phone line.

3. Plug the cord of the power supply into the power socket on the central router. Then plug the power supply into the onsite power outlet.

Checking for Correct Operation of the Central Router

When properly connected, the Power and Ethernet Port 1 lights on the central router illuminate.

Following these set-up steps, for example, the remote office system 10, including both the offsite system 20 and the onsite system 60, is ready for communication and work.

### EXAMPLE OF ASSEMBLY OF OFFSITE UNIT DURING MANUFACTURE

In general, the following steps are followed during assembly of the components of the offsite unit 21, wherein the router and terminal server may be acquired as off-the-shelf components for installation and adaptation for the invented system. These steps are detailed in the priority document for this application, Ser. No. 60/265715, filed Jan. 31, 2001, which is hereby incorporated herein.

1. Unpack and disassemble 24 or 48-port patch panel for adaptation and incorporation into Offsite Unit.

2. Enlarge holes in port blocks and drill holes in face trim.

3. Fill ports with epoxy.

4. Engraving/marking indicia on case of Offsite Unit.

5. Engraving/marking indicia on top internal panel of Offsite Unit.

6. Assemble case rim

7. Cut backboards

8. Make leg tabs for Etherlites

9. Prepare power cord storage straps

10. Make RJ45 CAT5 cables

11. Make RJ11 CAT5 cables

12. Make DB9 Serial Adapters

13. Make DB25 Serial Adapters

14. Test serial adapters

15. Drill holes in case and backboard

16. Press T-nuts into backboards

17. Mount back board in case

18. Stencil installation guides on backboard to ensure that components are anchored in Offsite Unit case as preferred.

19. Prepare case and case rim for adhesive

20. Glue rim in case

21. Apply storage pocket to inside of case lid

22. Inspect panel for defects

23. Attach LED cover lens to face panel

24. Insert cord grommet

25. Mount port blocks and trim pieces on panel

26. Attach power cord strap to top internal panel (“face panel”)

27. Punch-down CAT5 cabling

28. Test and number Cat5 cables

29. Install EtherLite™ terminal server into case in desired position

30. Install power adapters and power cord

31. Install WebRamp™ router into cased in desired position

32. Cover non-visible LEDs on WebRamp™

33. Install patch cable

34. Vacuum out the case for quality assurance

35. Install face panel

36. Apply serial number badge

37. Complete the Inventory Sheet for quality assurance

38. Test terminal ports

39. Update Offsite System router firmware

40. Change Offsite System router IP address

41. Upload Offsite System configuration

42. Update Central Router firmware

43. Change Central Router IP address

44. Upload Central Router configuration

45. Package Configured Offsite Unit

46. Change Offsite System Dial-out Phone Number

47. Change Etherlite IP Address

Examples of steps involved in above-listed as Steps 39-44, and 46 and 47 are illustrated below:

Update Offsite System Router Firmware

1. Launch TFTP server.

2. Open IE and click the link button for “192.168.1.1”.

a) Click Status.

b) F5

3. Verify correct MAC address on photocopy with RD Inventory Sheet.

4. Click Diagnostics>Upgrade Firmware

5. Enter 192.168.1.200 and filename 310ir13a25.bin.

6. Click Apply.

7. Wait until browser says “Firmware Upgrade Complete”.

8. Power cycle RD, and click F5, Click Status, and click F5

9. Verify MAC address and firmware version 1.3.0 on photocopy with RD Inventory Sheet.

Change Offsite System Router IP Address

1. Click the link button for “Change IP”

2. Type 192.111.111.11 in the IP address field and 255.255.255.248 in the subnet mask field. CAUTION! SETTING THE IP ADDRESS INCORRECTLY MAY CAUSE THE WEBRAMP TO BECOME INACCESSIBLE.

3. Click Apply, and wait for the change to take effect.

4. Power cycle RD.

5. Click the link button for “Offsite System”.

6. F5, and verify that the page reloads.

Upload Offsite System Configuration

1. Verify TFTP server is still running.

2. Click Diagnostics>Import Configuration

3. Enter 192.111.111.9 and filename offsite.bin

4. Click Import, and wait for upload to complete.

5. Click Reset WebRamp 310i and Apply.

6. F5

7. Click Advanced.

8. F5

9. Verify that Branch Office 1 profile is named “Outbound” and is enabled on modem 1.

10. Disconnect the Offsite System from the network and power.

Update Central Router Firmware

NOTE: Only one Central Router or Offsite System may be plugged into the network at a time.

1. Plug Central Router into hub.

2. Plug Central Router into power strip.

3. Launch TFTP server.

4. Open IE and click the link button for “192.168.1.1”.

5. Click Status

6. F5, and Verify correct MAC address on bottom of router.

7. Click Diagnostics>Upgrade Firmware

8. Enter 192.168.1.200 and filename 310ir13a25.bin.

9. Click Apply.

10. Wait until browser says “Firmware Upgrade Complete”.

11. Power cycle WebRamp.

12. F5, and Click Status.

13. F5, and verify MAC address and firmware version

1.3.0 on photocopy with RD Inventory Sheet.

Change Central Router IP Address

1. Click the link button for “Change IP”.

2. Type 192.1111.111.10 in the IP address field and 255.255.255.248 in the subnet mask field. CAUTION! SETTING THE IP ADDRESS INCORRECTLY MAY CAUSE THE WEBRAMP TO BECOME INACCESSIBLE.

3. Click Apply, and wait for the change to take effect.

4. Power cycle WebRamp.

5. Click the link button for “Central Router”.

6. F5, and verify that the page reloads.

Upload Central Router Configuration

1. Verify TFTP server is still running.

2. Click Diagnostics>Import Configuration

3. Enter 192.111.111.9 and filename central.bin.

4. Click Import, and wait for upload to complete.

5. Click Reset WebRamp 310i and Apply

6. F5, and click advanced.

7. F5, and verify that Branch Office 1 profile is named “Inbound” and is enabled on modem

Change Offsite System Dial-out Phone Number

1. Plug RD into hub.

2. Plug RD into power strip.

3. Click the link button for “Offsite System”.

4. Click Advanced

5. Click Branch Office 1.

6. Click Account Information.

7. Change “Phone Number to be used in Modem 1” to the number listed as “Dial in telephone #”.

a) Add any digits with a comma in front of the dial out number to match any numbers on the “Digits typically required to dial this line for offsite” line of the Customer Site Survey form.

I) For example this might be 9,343-5559 for a system that will dial a 9 first and then 343-5559.

ii) The comma is essential to allow for a pause after dialing digits for a line.

8. Click Apply.

9. F5

10. Verify that the page reloads and the phone number is correct.

11. Click the print button.

12. Attach printout to RD Inventory Sheet.

Change Etherlite IP Address

1. Launce Storeip.exe

2. Click File>Configure

3. Enter the correct Ethernet Address for the Etherlite on the top line.

4. The Ethernet Address will be on the photo of the Etherlite attached to the Offsite Unit! Inventory Sheet.

5. Locate the IP address to set on the Etherlite on the Customer Site Survey form. It will be on the line labeled “Available LAN IP address (for Etherlite)”.

6. Enter the IP address on both the Target IP Address and Host IP Address lines.

a) Confirm that the address is entered correctly on both lines.

b) Confirm that the radio button “Store IP” is marked.

c) Click OK.

7. Power cycle the Offsite Unit.

8. Wait until the Store IP program says “IP Address Stored”

9. Exit Store IP.

10. Record the IP Address set on Etherlite on the RD Inventory Sheet.

11. Record the Port Number range that this will assign for the dealership information system on the RD Inventory Sheet.

a) Refer to supporting systems documentation to determine these port numbers.

12. Put RD away in storage carton.

13. Initial the “Final Configuration for” box on the RD Assembly Checklist and write the customer's name from the RD Customer Site Survey form on the line below.

14. Store RD in the Shipping station.

In an especially-preferred embodiment, high impact plastic is used for the case and also for the backplate to which the components of the offsite unit 21 are attached. This improves strength and decreased weight compared to wood or other materials. The router of the offsite unit may be mounted to the top internal panel (face panel) with rubber mounts to reduce shock and vibration. Preferably, high impact plastic brackets are used for mounting the components inside the offsite unit case inside the interior space 122 of the case, between the bottom wall of the case and the panel 24. Routers using Linux™ as an operating system may be an alternative, preferred embodiment.

Although this invention has been described above with reference to particular means, materials and embodiments, it is to be understood that the invention is not limited to these disclosed particulars, but extends instead to all equivalents within the broad scope of this disclosure.

What is claimed is:

1. A remote office system comprising an onsite system for use in a home office and an offsite system for use at remote location distanced from the home office, wherein:
the onsite system comprises a central router adapted for connection to a computer network at the home office and adapted for connection to a telephone network;
the offsite system comprises an offsite unit including a single case, a modem router and a terminal server operative connected to each other and disposed in the single case, a patch panel connected to the terminal server and to the modem router, the patch panel being in the single case and accessible through a case panel, and a power cord operatively connected to the modem router and the terminal server and exiting the single case;
the offsite system further comprises dummy terminals connected to the patch panel;
wherein the offsite unit is pre-configured with a telephone dial-out number and a network address uniquely identifiable to the home office computer network, and allowing the offsite unit to contact and communicate with the home office computer network via the central router;
wherein information is transmitted from the dummy terminals to the home office computer network via the offsite unit, the telephone network and the central router and information is transmitted in reverse from the home office computer network via the central router, the telephone network, and the offsite unit, to the dummy terminals.

2. A remote office system as in claim 1, wherein the entire modem router and entire terminal server are located inside the case and not accessible to a user.

3. A remote office system as in claim 2, wherein the modem router and terminal server are locked inside the case in an interior space below a top internal panel and are not programmable and not configurable when inside the case below the top internal panel.

4. A remote office system as in claim 1, wherein the patch panel is connected to from one to sixteen of said dummy terminals.

5. A remote office system as in claim 3, wherein the case comprises a pressure relief valve for equalizing pressure in the interior space with surrounding atmospheric pressure.

6. A remote office system comprising an onsite system for use in an office with a computer network, and an offsite system for use at remote location distanced from the office, wherein:
the onsite system comprises a central router adapted for connection to the computer network at the office and adapted for connection to a wireless or wired long distance communications network;
the offsite system comprises a plurality of dummy computer terminals, and an offsite unit including means for connecting to the long distance communications network and to the plurality of dummy computer terminals, wherein said means are enclosed in a single transportable case, and wherein said means comprises pre-configuration so that said means automatically, upon being supplied with power and connection to the long distance communication network, contacts the onsite system central router and conducts two-way communication with the computer network at the office.

7. A remote office system as in claim 6, wherein said pre-configuration comprises a pre-configured telephone dial-out number and a pre-configured network address uniquely identifying the office computer network.

8. A method of communication between a home office and a remote sales and services location, the method comprising:
providing an onsite system in a home office and an offsite system in a remote location distanced from the home office;
wherein the onsite system comprises a central router adapted for connection to a computer network at the home office and adapted for connection to a telephone network;
wherein the offsite system comprises a plurality of dummy terminals and an offsite unit, the offsite unit including a single case, a modem router and a terminal server operative connected to each other and disposed in the single case, a patch panel connected to the terminal server, the modem router, and the plurality of dummy terminals, the patch panel being in the single case and accessible through a case panel, and a power cord operatively connected to the modem router and the terminal server and exiting the single case;
the method further comprising pre-configuring the offsite unit, before placement of the offsite unit at the remote location, with a telephone dial-out number and a network address uniquely identifiable to the office computer network and means to automatically dial-up and communicate with the office computer network via the central router when power is supplied to the offsite unit.

9. A method as in claim 8, wherein the entire modem router and entire terminal server are located inside the case and not accessible to a user.

10. A method as in claim 9, wherein the modem router and terminal server are locked inside the case in an interior space below a top internal panel and are not programmable and not configurable when inside the case below the top internal panel.

11. A method as in claim 1, wherein the patch panel is connected to from one to sixteen of said plurality of dummy terminals.

12. A remote office system as in claim 10, wherein the case comprises a pressure relief valve for equalizing pressure in the interior space with surrounding atmospheric pressure.
